(19) United States
(12) Patent Application Publication
(10) Pub. No.: US 2015/0091713 A1
(43) Pub. Date: Apr. 2, 2015

(54) SYSTEM AND METHOD FOR VEHICLE THEFT DETECTION

(71) Applicants: Tobias Kohlenberg, Portland, OR (US); Dave Paul Singh, Portland, OR (US); Dominic Fulginiti, Beaverton, OR (US); Mahendra Tadi Tadikonda, Portland, OR (US)

(72) Inventors: Tobias Kohlenberg, Portland, OR (US); Dave Paul Singh, Portland, OR (US); Dominic Fulginiti, Beaverton, OR (US); Mahendra Tadi Tadikonda, Portland, OR (US)

(21) Appl. No.: 14/125,141

(22) PCT Filed: Sep. 27, 2013
(86) PCT No.: PCT/US2013/062439

§ 371 Date: Dec. 10, 2013

(51) Int. Cl. B60R 25/32; B60R 25/33; B60R 25/102

(52) U.S. Cl. CPC B60R 25/32; B60R 25/102; B60R 25/33
USPC 340/426.36

(57) ABSTRACT

Various systems and methods for vehicle theft detection are described herein. In an embodiment, a driver of the vehicle is identified with an onboard system. The onboard system then determines whether the driver is an authorized operator of the vehicle, where the determination based on sensor data collected from a sensor installed in the vehicle. When the driver is not an authorized operator of the vehicle, a security recovery process is performed.

### TECHNICAL FIELD

Embodiments described herein generally relate to vehicles and in particular, to a system and method for vehicle theft detection.

### BACKGROUND

Vehicle theft is a common criminal behavior. Vehicles are expensive, often left unattended for long periods of time, and are consequently relatively attractive to access and steal. Theft prevention and mitigation is implemented in various ways, such as by the use of alarms or tracking systems.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic drawing illustrating a vehicle theft detection system, according to an embodiment;

FIG. 2 is a block diagram of the processing modules of the system shown in FIG. 1 according to various embodiments;

FIG. 3 is a block diagram illustrating a system to capture/process data from a vehicle, according to an embodiment;

FIG. 4 is a flowchart illustrating a method of detecting vehicle theft of a vehicle, according to an embodiment; and

FIG. 5 is a block diagram illustrating an example machine upon which any one or more of the techniques (e.g., methodologies) discussed herein may perform, according to an example embodiment.

### DETAILED DESCRIPTION

Preventing vehicle theft may be achieved through various mechanisms, such as by preventing access, intrusion detection systems, and location tracking systems. Preventing access is a first line of defense against theft. Access prevention may be provided by way of locks, security keys (e.g., a key fob with radio frequency identification (RFID)), or the like. If a potential thief gains access to a vehicle, the next line of defense is an intrusion detection system. Most intrusion detection systems include an alarm to notify people nearby of the criminal activity. Alarms may also notify the vehicle owner, police, or other entities. Other intrusion detection systems may disable the vehicle (e.g., an ignition lock). If the intrusion detection system is bypassed or ineffective, the thief may be tracked with a tracking system. Some tracking systems use a global positioning system (GPS) that provides the location of the vehicle to authorities (e.g., a security firm or the police).

With the additional sensors that exist in current models and sensors that may be introduced in future models, vehicles may be equipped in a manner that allows for dynamic evaluation of whether a vehicle is being operated by an unauthorized person, such as a thief.

Personal driving style is sufficiently distinct when enough characteristics are taken into account. Modern cars include a wide array of sensors, such as a seat pressure sensor, an accelerometer, a microphone, pedal pressure sensors, seat positions sensors, and other environmental and telematics sensors. Sensor data obtained from such sensors may be used to create a behavioral profile for each regular driver, and enable an onboard system to determine whether the vehicle has been stolen, even in the case where the key, key fob, or smart phone key is still in the vehicle.

The present disclosure describes a secure processing engine to support collection, analysis, and monitoring of behavior data to perform learning and anomaly detection. The behavior and anomaly detection may be performed using various behavioral analysis and prediction methods. When a new legitimate driver is introduced to the vehicle, the vehicle is placed into an initialization (e.g., training) mode by the owner or other authorized person (e.g., car dealer). The new driver is assigned an identity in the onboard system and associated with a key fob or biometric data of the new driver. As the new driver operates the vehicle, the vehicle collects behavioral data. After the new driver has operated the vehicle for a sufficient time, or after a sufficient amount of data has been collected, a profile is considered complete for that new driver. During daily use, after the vehicle determines which driver identity is active, the secure processing engine may perform continuous or intermittent monitoring and analysis to detect anomalies in the driver's behavior. The driver behavior anomalies are detected, the secure processing engine may refer to a policy engine to determine an appropriate response. Some examples of responses include disabling the engine, recording and broadcasting the vehicle's location to a predefined service, or activating the vehicle alarm.

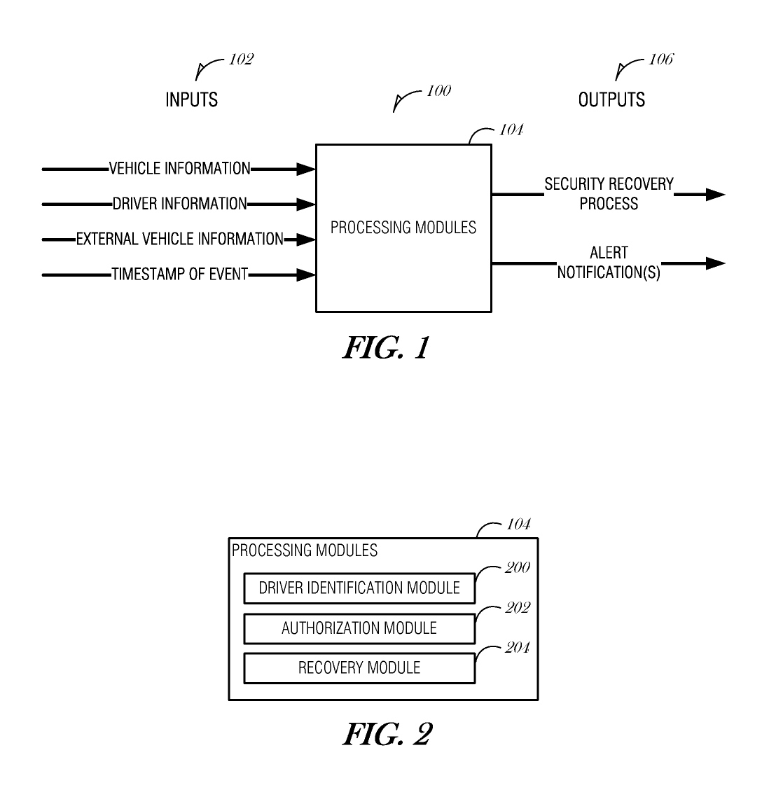

FIG. 1 is a schematic drawing illustrating a vehicle theft detection system 100, according to an embodiment. The vehicle theft detection system 100 may be a computer system and may be installed in a vehicle. The vehicle theft detection system 100 may be a discrete system in a vehicle. Alternatively, the vehicle theft detection system 100 may be a portion of a larger system, such as a navigation system or a vehicle intelligence system. In addition, the vehicle theft detection system 100 may be integrated with sensors or other systems in the vehicle, such as safety systems, security systems, navigation systems, driving systems, or environmental systems.

Safety systems may include lap belt systems, door lock systems, or driving light systems. Security systems may include alarm systems or emergency response alert systems. Navigation systems may include global positioning systems, road sensing systems, beacon sensing systems, mapping systems, or traffic routing systems. Driving systems may include cruise control, braking, or attitude control systems. Environmental systems may include heating and ventilation systems, lighting systems, audio systems, or a heads up display system.

Inputs 102 are received by processing module 104 and processed into outputs 106. The inputs 102 may include vehicle information, driver information, external vehicle information, and a timestamp of the event among other inputs.

An input 102 may be vehicle information. Data may be obtained regarding the state of a vehicle system. The term vehicle includes any machine used to transport people or objects, including but not limited to cars, trucks, motorcycles, boats, and airplanes. Vehicle information may include information including, but not limited to acceleration and deceleration trends, braking use, time or duration of vehicle operation, pedal pressure, seat pressure (for determining driver weight or distribution), seat position, lap belt use, side view or rear view mirror position/orientation, steering column position, lap belt extension, and the like.

Another input 102 may be driver information. Driver information may be obtained with a biometric sensor, for example a fingerprint scanner, a retina scanner, a camera, or a voice recognition system. Other driver-related information may be used to derive or make an educated guess as to the driver's identity. For example, one or more seat sensors may measure the driver's weight or weight distribution, using one or both of these measurements, the processing modules 104 may identify a driver with some level of confidence.

Yet another input 102 may be external vehicle information. External vehicle information may be any information related to events or objects that occur or exist outside of the vehicle. For example, a location system (e.g., GPS) may be used to track the location of the vehicle. As another example, sensors may be used to determine or obtain weather-related information. For example, if a driver operates a vehicle in a certain manner during particular weather (e.g., drives slowly during a rain shower), a different driver who operates the vehicle in a different manner (e.g., drives fast during a rain shower) may be an unauthorized driver.

Yet another input 102 may be timestamp data. A timestamp may be a sequence of characters denoting the date and/or time at which a certain event occurred. A global positioning system may be incorporated to provide a timestamp and location of the event.

Additionally or alternatively, input 102 may include access detection monitors. Physical access may be detected using other sensors, such as a motion detector adapted to detect motion within the vehicle's cabin, a seat sensor to detect weight on the driver's seat, an audio sensor to detect noise within the vehicle, or an infrared sensor to detect a heat signature within the vehicle.

The processing modules 104 receive inputs 102 and apply the inputs 102 to capture, process, and transmit data, according to various embodiments. The processing modules 104 are described in more detail by reference to FIG. 2. In an embodiment, inputs 102 are received by processing modules 104 and applied to determine whether the driver is an authorized driver. In an embodiment, inputs 102 collectively or individually, may be applied to capture and analyze vehicle, driver, or other data and subsequently determine whether the current driver is an authorized driver.

The outputs 106 include a security recovery process and providing alert notifications. If the current driver is not authorized (e.g., not recognized), the processing modules may perform one or more security recovery processes, which may include transmitting one or more alert notifications. As an example, based on inputs 102, the processing modules 104 may determine that a vehicle has been stolen and disable the vehicle (security recovery process) and output an alert to an emergency response service (e.g., place an automated 911 call)

FIG. 2 is a block diagram of the processing modules 104 of the system shown in FIG. 1 according to various embodiments. The processing modules 104 comprise a driver identification module 200, an authorization module 202, and a recovery module 204.

The driver identification module 200 is adapted to identify a driver of the vehicle, according to an embodiment. In an embodiment, to identify the driver, the driver identification module 200 is adapted to: detect physical access to the vehicle; obtain a biometric identification of a person accessing the vehicle; and use the biometric identification to determine the driver identification. Physical access may be detected by interfacing with the central locking system (e.g., to detect a door unlock command). Additionally or alternatively, physical access may be detected using other sensors, such as a motion detector adapted to detect motion within the vehicle's cabin, a seat sensor to detect weight on the driver's seat, an audio sensor to detect noise within the vehicle, or an infrared sensor to detect a heat signature within the vehicle.

Biometric information includes information about the person, such as physical traits or other characteristics. Examples of biometric identifiers include, but are not limited to fingerprints, facial recognition, palm print, hand geometry, iris or retina recognition, and voice recognition. The biometric information may be obtained passively or actively. In a passive mechanism, the person's information may be obtained without the person knowing or without directly requesting the information from the person. In this mode, the vehicle system passively monitors the person and receives data when it is available (e.g., after a person grips the steering wheel or talking spontaneously). In an active mode, the vehicle system may request or require biometric authentication before allowing the vehicle to start or be shifted into drive. For example, the vehicle system may request that the driver identify himself by speaking a passphrase, swiping a finger over a fingerprint scanner, or looking directly at a video camera for facial or retina recognition. Using these various methods, the system may identify the driver.

In an embodiment, the physical access comprises unlocking a door of the vehicle. For example, some vehicles are equipped with a touch-sensitive door handle that actuates the locking mechanism. In such vehicles, a fingerprint scanner may be incorporated into the touch surface of the door handle to scan the person's finger at the time of unlocking the vehicle.

In another embodiment, to identify the driver, the driver identification module 200 is adapted to: detect a key fob; obtain an identification value from the key fob; and correlate the identification value with the driver. For example, an onboard system may store several driver profiles and use a screen-based system to display driver profiles to the driver. During an initialization routine (e.g., learning period), the driver may initially associate a key fob with the driver's profile. The key fob may be uniquely identified by a global unique identifier (GUID), which may be transmitted from the key fob to the vehicle, such as by way of a radio-frequency identification (RFID) mechanism. As such, when a person approaches or enters a vehicle with a particular key fob, the vehicle system may correlate that key fob with a particular driver profile (e.g., driver identity).

The authorization module 202 is adapted to determine whether the driver is an authorized operator of the vehicle, the determination based on sensor data collected from a sensor installed in the vehicle, according to various embodiments. To determine whether a driver is an authorized operator, the driver's identity is compared to a list of authorized operators. The list of authorized operators may be the collection of known driver profiles.

In an embodiment, the authorization module 202 is adapted to determine whether the driver is the authorized operator, the authorization module 202 is adapted to: build a contemporaneous driver profile based on contemporaneous sensor data; access a driver profile database to obtain a historical driver profile; and compare the contemporaneous driver profile with the historical driver profile to determine whether the driver profile and historical driver profile are different. The contemporaneous driver profile is a driver profile based on the driver's current or recent activity (e.g., during the current trip). By comparing the driver's driving profile with past driving characteristics (e.g., stored in a historical driver profile), the system may determine whether the current driver is the imputed driver (e.g., the driver identified from above). For example, a contemporaneous driver profile may include indications that the current driver accelerates quickly from stops, takes turns at a high speed, or brakes hard to come to a stop. When compared to a historical driver profile of an owner/driver who is a more conservative driver that does not accelerate hard or brake hard, the authorization module 202 may determine that the current driver is an unauthorized operator.

In an embodiment, to build the contemporaneous driver profile, the authorization module 202 is adapted to: record sensor data; and associate the sensor data with the driver. For example, while the operator is driving, various sensor data may be obtained, such as acceleration characteristics, and associated with the driver. Other sensor data may be obtained and stored. As such, in a further embodiment, to record sensor data, the authorization module 202 is adapted to perform at least one of: recording trends of vehicle acceleration; recording trends of vehicle deceleration; recording seat pressure sensor data; or recording an audio signature of the driver.

In an embodiment, to compile the historical driver profile, the authorization module 202 is adapted to: enter an initialization mode for a new driver; collect and store sensor data for the new driver; compile the sensor data to create the historical driver profile for the new driver; and store the historical driver profile in a data store in the vehicle. For example, the vehicle may have an initialization mode or learning period where the driver is monitored and various characteristics of the driver or driving habits are obtained, recorded, and processed. For example, acceleration, deceleration, average speed, and other driving characteristics are largely similar from day to day for a driver who commutes the same route daily. By recording and trending these types of values, anomalies in driving behavior may be detected, suggesting that the current driver is not the same as the driver associated with the historical driver profile.

The recovery module 204 is adapted to perform a security recovery process when the driver is not an authorized operator of the vehicle, according to various embodiments. In an embodiment, to perform the security recovery process, the recovery module 204 is adapted to disable the vehicle. For example, many vehicles are equipped with a “kill switch.” The kill switch disables the vehicle's ignition or other components in a manner that the vehicle cannot be started or run. The kill switch may be activated remotely. However, in the embodiments described herein, the kill switch may be activated by the vehicle theft detection system 100. In another embodiment, to perform the security recovery process, the recovery module 204 is adapted to activate a vehicle alarm.

In some cases, such as during an emergency, an operator may desire to disable the recovery module 204 or other components of the system so that the system does not inadvertently disable the vehicle during operation. Thus, in an embodiment, the recovery module 204 or other aspects of the system may be disabled temporarily or permanently. To disable or enable the system, various types of access controls may be used, such as a username and password, biometric authentication, a key fob, or other mechanisms to ensure that the owner or other authorized operator is the one disabling or enabling the system.

In another embodiment, to perform the security recovery process, the recovery module 204 is adapted to transmit a message to a person, such as an owner of the vehicle, a law enforcement agent, or a third-party authorized by the owner. In an embodiment, to perform the security recovery process, the recovery module 204 is adapted to transmit a geographic position of the vehicle to at least one of: an owner of the vehicle, a law enforcement agent, or a third-party authorized by the owner. The third-party may include various people or entities, such as an insurance company, a road-side assistant (e.g., OnStar® from General Motors®), or a relative of the owner's (e.g., the driver's parents). Messages may be transmitted using any of a variety of transmission protocols or mechanisms, including but not limited to cellular transmission, Wi-Fi®, or satellite. Messages may be encrypted using a variety of cryptographic mechanisms (e.g., protocols), such as secure sockets layer (SSL), transport layer security (TLS), asymmetrical key encryption such as Pretty Good Privacy (PGP), or IP security (IPSec).

In an embodiment, to perform the security recovery process, the recovery module 204 is adapted to: access a policy store, the policy store including a rule correlating a threshold condition with a security response; select the rule based on the sensor data; and select the security response when the threshold condition is violated. An example of a rule that may exist in the policy store is “If seat sensor detects weight greater than 10% over or under any known driver profile, then transmit alert to owner.” Another example of a rule is “If braking characteristics indicate driver is not actual driver associated with profile, then disable vehicle and transmit message to owner and police.” The rules may be configured by the owner, another user, or other people (e.g., police). The rules may be active during certain periods of time (e.g., during the night). It is understood that rules may include one or more sensor values, one or more thresholds with respect to the sensor values, and one or more actions based on violations of one or more of the thresholds. For example, a rule may include “If the driver brakes with a brake pedal pressure of 20% greater force than a known driver profile, then trigger alert.”

In various embodiments, information may be obtained by the driver identification module 200 or the authorization module 202 using a plurality of onboard sensors connected to a vehicle. Information may also be captured by onboard or remote processing devices.

FIG. 3 is a block diagram illustrating a system 300 to capture/process data from a vehicle, according to an embodiment. FIG. 3 represents one possible embodiment of a vehicle theft detection system 100 (as described in FIG. 1). The system 300 comprises a plurality of onboard sensors 302A, 302B, 302C to capture vehicle and driver information, and an onboard processing device 304 to analyze and process the data. The onboard processing device 304 includes processing modules 306 (e.g., processing modules 104), storage 308, and a networking device 310 to establish a remote connection capable of sending and receiving event data to and from external sources. The external sources may include data stores to maintain a history of sensor data, profiles, user preferences, or the like.

A plurality of onboard sensors is shown in block 302. These onboard sensors 302 may be connected to a vehicle to measure physical quantities of force registered upon impact to the vehicle. The onboard sensors 302 may receive a signal or stimulus, and respond to that signal or stimulus in a distinctive manner. The plurality of onboard sensors 302 may be linked to an onboard processing device 304. Examples of onboard sensors, which may be incorporated in the present disclosure include, but are not limited to sensors for the drivetrain, engine, automotive body, vehicle control, passenger comfort, passenger convenience, emission control, electrical devices, vehicle maintenance, crash avoidance, hybrid and fuel cell management, among others.

The onboard processing device 304 is coupled to the plurality of onboard sensors 302. The onboard processing device 304 may be any device having a processor (e.g., microprocessor) capable of processing data. In an embodiment, the onboard processing device 304 may be a computer system embedded in a vehicle. The onboard processing device 304 may include processing modules 306, such as those described above with respect to FIGS. 1-2, and storage 308. The storage 308 may be a memory device, such as a hard drive, flash memory drive, optical drive, or other type of data storage device. The storage 308 may be used to store contemporaneous sensor data, driver profiles, policies and rules, threshold values, and other information used in the driver monitoring and security recovery processes.

The networking device 310 may be connected to the onboard processing device 304 and be used to establish a remote connection capable of sending and receiving event data to and from external sources (e.g., external sensors, location systems such as GPS, and the like). The networking device 310 may also be used to transmit messages, such as messages to the police, owner, or other third-party regarding possible vehicle theft. The networking device 310 may be combined with the onboard processing device 304, and may contain the necessary hardware and software to connect using a wireless networking protocol. The networking device 310 may establish a network connection with a satellite or telecommunication network. In one embodiment, the networking device 310 may be capable of connecting to wireless hotspot locations.

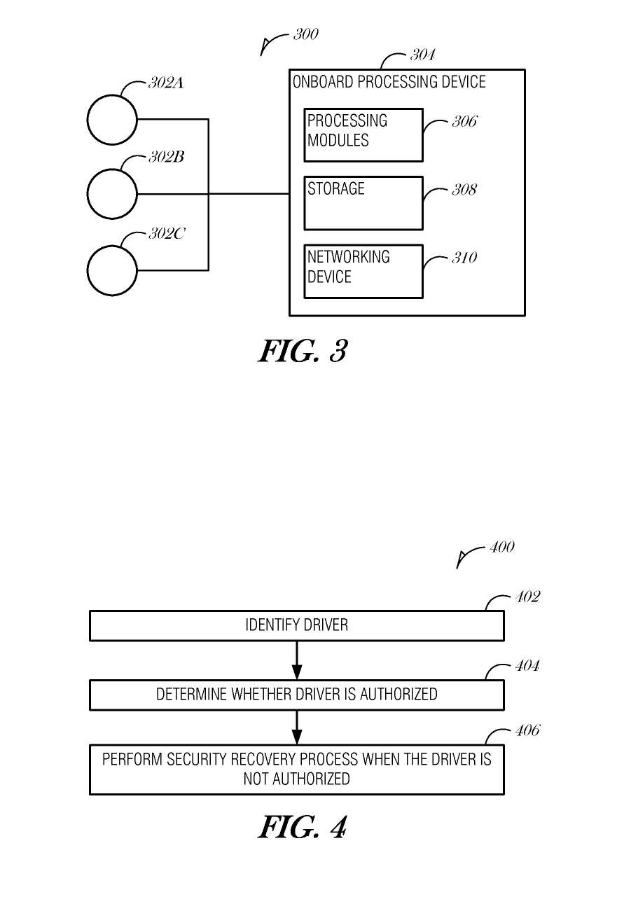

FIG. 4 is a flowchart illustrating a method 400 of detecting vehicle theft of a vehicle, according to an embodiment. At block 402, a driver of the vehicle is identified with an onboard system. In an embodiment, identifying the driver comprises: detecting physical access to the vehicle; obtaining a biometric identification of a person accessing the vehicle; and using the biometric identification to determine the driver identification. In an embodiment, the physical access comprises unlocking a door of the vehicle.

In another embodiment, identifying the driver comprises: detecting a key fob; obtaining an identification value from the key fob; and correlating the identification value with the driver.

At block 404, whether the driver is an authorized operator of the vehicle is determined by the onboard system, where the determination based on sensor data collected from a sensor installed in the vehicle.

In an embodiment, determining whether the driver is the authorized operator comprises: building a contemporaneous driver profile based on contemporaneous sensor data; accessing a driver profile database to obtain a historical driver profile; and comparing the contemporaneous driver profile with the historical driver profile to determine whether the driver profile and historical driver profile are different.

In an embodiment, the historical driver profile is compiled by: entering an initialization mode for a new driver; collecting and storing sensor data for the new driver; compiling the sensor data to create the historical driver profile for the new driver; and storing the historical driver profile in a data store in the vehicle.

In an embodiment, building the contemporaneous driver profile comprises: recording sensor data; and associating the sensor data with the driver. In an embodiment, recording sensor data comprises at least one of: recording trends of vehicle acceleration; recording trends of vehicle deceleration; recording seat pressure sensor data; or recording an audio signature of the driver.

At block 406, a security recovery process is performed when the driver is not an authorized operator of the vehicle. In an embodiment, performing the security recovery process comprises disabling the vehicle. In another embodiment, performing the security recovery process comprises activating a vehicle alarm.

In an embodiment, performing the security recovery process comprises transmitting a message to a person. The person may be an owner of the vehicle, a law enforcement agent, or a third-party authorized by the owner, according to various embodiments.

In an embodiment, performing the security recovery process comprises transmitting a geographic position of the vehicle to at least one of: an owner of the vehicle, a law enforcement agent, or a third-party authorized by the owner.

In an embodiment, performing the security recovery process comprises: accessing a policy store, the policy store including a rule correlating a threshold condition with a security response; selecting the rule based on the sensor data; and selecting the security response when the threshold condition is violated.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time.

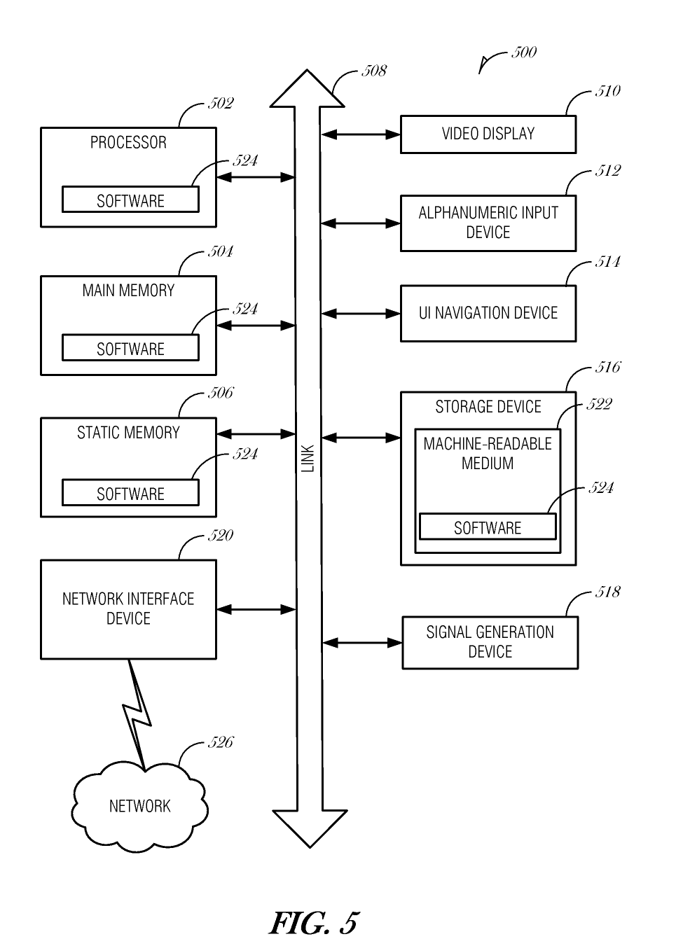

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, personal computer (PC), a tablet PC, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 includes subject matter (such as a device, apparatus, or machine) comprising an onboard system for detecting vehicle theft, the onboard system installed on a vehicle and comprising: a driver identification module adapted to identify a driver of the vehicle; an authorization module adapted to determine whether the driver is an authorized operator of the vehicle, the determination based on sensor data collected from a sensor installed in the vehicle; and a recovery module adapted to perform a security recovery process when the driver is not an authorized operator of the vehicle.

In Example 2, the subject matter of Example 1 may optionally include, wherein to identify the driver, the driver identification module is adapted to: detect physical access to the vehicle; obtain a biometric identification of a person accessing the vehicle; and use the biometric identification to determine the driver identification.

In Example 3 the subject matter of any one or more of Examples 1 to 2 may optionally include, wherein the physical access comprises unlocking a door of the vehicle.

In Example 4 the subject matter of any one or more of Examples 1 to 3 may optionally include, wherein to identify the driver, the driver identification module is adapted to: detect a key fob; obtain an identification value from the key fob; and correlate the identification value with the driver.

In Example 5 the subject matter of any one or more of Examples 1 to 4 may optionally include, wherein to determine whether the driver is the authorized operator, the authorization module is adapted to: build a contemporaneous driver profile based on contemporaneous sensor data; access a driver profile database to obtain a historical driver profile; and compare the contemporaneous driver profile with the historical driver profile to determine whether the driver profile and historical driver profile are different.

In Example 6 the subject matter of any one or more of Examples 1 to 5 may optionally include, wherein to build the contemporaneous driver profile, the authorization module is adapted to: record sensor data; and associate the sensor data with the driver.

In Example 7 the subject matter of any one or more of Examples 1 to 6 may optionally include, wherein to record sensor data, the authorization module is adapted to perform at least one of: record trends of vehicle acceleration; record trends of vehicle deceleration; record seat pressure sensor data; or record an audio signature of the driver.

In Example 8 the subject matter of any one or more of Examples 1 to 7 may optionally include, wherein to compile the historical driver profile, the authorization module is adapted to: entering an initialization mode for a new driver; collect and store sensor data for the new driver; compile the sensor data to create the historical driver profile for the new driver; and store the historical driver profile in a data store in the vehicle.

In Example 9 the subject matter of any one or more of Examples 1 to 8 may optionally include, wherein to perform the security recovery process, the recovery module is adapted to disable the vehicle.

In Example 10 the subject matter of any one or more of Examples 1 to 9 may optionally include, wherein to perform the security recovery process, the recovery module is adapted to activate a vehicle alarm.

In Example 11 the subject matter of any one or more of Examples 1 to 10 may optionally include, wherein to perform the security recovery process, the recovery module is adapted to transmit a message to a person.

In Example 12 the subject matter of any one or more of Examples 1 to 11 may optionally include, wherein the message is transmitted to an owner of the vehicle.

In Example 13 the subject matter of any one or more of Examples 1 to 12 may optionally include, wherein the message is transmitted to a law enforcement agent.

In Example 14 the subject matter of any one or more of Examples 1 to 13 may optionally include, wherein the message is transmitted to a third-party authorized by the owner.

In Example 15 the subject matter of any one or more of Examples 1 to 14 may optionally include, wherein to perform the security recovery process, the recovery module is adapted to transmit a geographic position of the vehicle to at least one of: an owner of the vehicle, a law enforcement agent, or a third-party authorized by the owner.

In Example 16 the subject matter of any one or more of Examples 1 to 15 may optionally include, wherein to perform the security recovery process, the recovery module is adapted to: access a policy store, the policy store including a rule correlating a threshold condition with a security response; select the rule based on the sensor data; and select the security response when the threshold condition is violated.

Example 17 includes or may optionally be combined with the subject matter of any one of Examples 1-16 to include subject matter for detecting vehicle theft (such as a method, means for performing acts, machine readable medium including instructions that when performed by a machine cause the machine to performs acts, or an apparatus configured to perform) comprising identifying a driver of the vehicle with an onboard system; determining, by the onboard system, whether the driver is an authorized operator of the vehicle, the determination based on sensor data collected from a sensor installed in the vehicle; and performing a security recovery process when the driver is not an authorized operator of the vehicle.

In Example 18, the subject matter of Example 17 may optionally include, wherein identifying the driver comprises: detecting physical access to the vehicle; obtaining a biometric identification of a person accessing the vehicle; and using the biometric identification to determine the driver identification.

In Example 19 the subject matter of any one or more of Examples 17 to 18 may optionally include, wherein the physical access comprises unlocking a door of the vehicle.

In Example 20 the subject matter of any one or more of Examples 17 to 19 may optionally include, wherein identifying the driver comprises: detecting a key fob; obtaining an identification value from the key fob; and correlating the identification value with the driver.

In Example 21 the subject matter of any one or more of Examples 17 to 20 may optionally include, wherein determining whether the driver is the authorized operator comprises: building a contemporaneous driver profile based on contemporaneous sensor data; accessing a driver profile database to obtain a historical driver profile; and comparing the contemporaneous driver profile with the historical driver profile to determine whether the driver profile and historical driver profile are different.

In Example 22 the subject matter of any one or more of Examples 17 to 21 may optionally include, wherein the historical driver profile is compiled by: entering an initialization mode for a new driver; collecting and storing sensor data for the new driver; compiling the sensor data to create the historical driver profile for the new driver; and storing the historical driver profile in a data store in the vehicle.

In Example 23 the subject matter of any one or more of Examples 17 to 22 may optionally include, wherein building the contemporaneous driver profile comprises: recording sensor data; and associating the sensor data with the driver.

In Example 24 the subject matter of any one or more of Examples 17 to 23 may optionally include, wherein recording sensor data comprises at least one of: recording trends of vehicle acceleration; recording trends of vehicle deceleration; recording seat pressure sensor data; or recording an audio signature of the driver.

In Example 25 the subject matter of any one or more of Examples 17 to 24 may optionally include, wherein performing the security recovery process comprises disabling the vehicle.

In Example 26 the subject matter of any one or more of Examples 17 to 25 may optionally include, wherein performing the security recovery process comprises activating a vehicle alarm.

In Example 27 the subject matter of any one or more of Examples 17 to 26 may optionally include, wherein performing the security recovery process comprises transmitting a message to a person.

In Example 28 the subject matter of any one or more of Examples 17 to 27 may optionally include, wherein the message is transmitted to an owner of the vehicle.

In Example 29 the subject matter of any one or more of Examples 17 to 28 may optionally include, wherein the message is transmitted to a law enforcement agent.

In Example 30 the subject matter of any one or more of Examples 17 to 29 may optionally include, wherein the message is transmitted to a third-party authorized by the owner.

In Example 31 the subject matter of any one or more of Examples 17 to 30 may optionally include, wherein performing the security recovery process comprises transmitting a geographic position of the vehicle to at least one of: an owner of the vehicle, a law enforcement agent, or a third-party authorized by the owner.

In Example 32 the subject matter of any one or more of Examples 17 to 31 may optionally include, wherein performing the security recovery process comprises: accessing a policy store, the policy store including a rule correlating a threshold condition with a security response; selecting the rule based on the sensor data; and selecting the security response when the threshold condition is violated.

Example 33 includes or may optionally be combined with the subject matter of any one of Examples 1-31 to include a computer-readable medium including instructions that when performed by a machine cause the machine to performs any one of the examples of 1-31.

Example 34 includes or may optionally be combined with the subject matter of any one of Examples 1-31 to include subject matter for detecting vehicle theft comprising means for performing any one of the examples of 1-31.

Example 35 includes an onboard system for detecting vehicle theft, the onboard system installed on a vehicle and comprising: means for identifying a driver of the vehicle; means for determining whether the driver is an authorized operator of the vehicle, the determination based on sensor data collected from a sensor installed in the vehicle; and means for performing a security recovery process when the driver is not an authorized operator of the vehicle.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1-25. (canceled)

26. An onboard system for detecting vehicle theft, the onboard system installed on a vehicle and comprising:
a driver identification module adapted to identify a driver of the vehicle;
an authorization module adapted to determine whether the driver is an authorized operator of the vehicle, the determination based on sensor data collected from a sensor installed in the vehicle; and
a recovery module adapted to perform a security recovery process when the driver is not an authorized operator of the vehicle.

27. The onboard system of claim 26, wherein to identify the driver, the driver identification module is adapted to:
detect physical access to the vehicle;
obtain a biometric identification of a person accessing the vehicle; and
use the biometric identification to determine the driver identification.

28. The onboard system of claim 27, wherein the physical access comprises unlocking a door of the vehicle.

29. The onboard system of claim 26, wherein to identify the driver, the driver identification module is adapted to:
detect a key fob;
obtain an identification value from the key fob; and
correlate the identification value with the driver.

30. The onboard system of claim 26, wherein to determine whether the driver is the authorized operator, the authorization module is adapted to:
build a contemporaneous driver profile based on contemporaneous sensor data;
access a driver profile database to obtain a historical driver profile; and
compare the contemporaneous driver profile with the historical driver profile to determine whether the driver profile and historical driver profile are different.

31. The onboard system of claim 30, wherein to build the contemporaneous driver profile, the authorization module is adapted to:
record sensor data; and
associate the sensor data with the driver.

32. The onboard system of claim 31, wherein to record sensor data, the authorization module is adapted to perform at least one of:
record trends of vehicle acceleration;
record trends of vehicle deceleration;
record seat pressure sensor data; or
record an audio signature of the driver.

33. The onboard system of claim 30, wherein to compile the historical driver profile, the authorization module is adapted to:
entering an initialization mode for a new driver;
collect and storing sensor data for the new driver;
compile the sensor data to create the historical driver profile for the new driver; and
store the historical driver profile in a data store in the vehicle.

34. The onboard system of claim 26, wherein to perform the security recovery process, the recovery module is adapted to disable the vehicle, activate a vehicle alarm, or transmit a message to a person, the person being one of an owner of the vehicle, a law enforcement agent, or a third-party authorized by the owner.

35. The onboard system of claim 26, wherein to perform the security recovery process, the recovery module is adapted to transmit a geographic position of the vehicle to at least one of: an owner of the vehicle, a law enforcement agent, or a third-party authorized by the owner.

36. The onboard system of claim 26, wherein to perform the security recovery process, the recovery module is adapted to:
access a policy store, the policy store including a rule correlating a threshold condition with a security response;
select the rule based on the sensor data; and
select the security response when the threshold condition is violated.

37. A method for detecting vehicle theft of a vehicle, the method comprising:
identifying a driver of the vehicle with an onboard system;
determining, by the onboard system, whether the driver is an authorized operator of the vehicle, the determination based on sensor data collected from a sensor installed in the vehicle; and
performing a security recovery process when the driver is not an authorized operator of the vehicle.

38. The method of claim 37, wherein identifying the driver comprises:
detecting physical access to the vehicle;
obtaining a biometric identification of a person accessing the vehicle; and
using the biometric identification to determine the driver identification.

39. The method of claim 38, wherein the physical access comprises unlocking a door of the vehicle.

40. The method of claim 37, wherein identifying the driver comprises:
detecting a key fob;
obtaining an identification value from the key fob; and
correlating the identification value with the driver.

41. The method of claim 37, wherein determining whether the driver is the authorized operator comprises:
building a contemporaneous driver profile based on contemporaneous sensor data;
accessing a driver profile database to obtain a historical driver profile; and
comparing the contemporaneous driver profile with the historical driver profile to determine whether the driver profile and historical driver profile are different.

42. The method of claim 41, wherein the historical driver profile is compiled by:
entering an initialization mode for a new driver;
collecting and storing sensor data for the new driver;
compiling the sensor data to create the historical driver profile for the new driver; and
storing the historical driver profile in a data store in the vehicle.

43. A computer-readable medium comprising instructions for detecting vehicle theft of a vehicle, which when executed by a computer, cause the computer to:
identify a driver of the vehicle with an onboard system;
determine, by the onboard system, whether the driver is an authorized operator of the vehicle, the determination based on sensor data collected from a sensor installed in the vehicle; and
perform a security recovery process when the driver is not an authorized operator of the vehicle.

44. The computer-readable medium of claim 43, wherein the instructions to identify the driver comprise instructions to:
detect physical access to the vehicle;
obtain a biometric identification of a person accessing the vehicle; and
use the biometric identification to determine the driver identification.

45. The computer-readable medium of claim 43, wherein the instructions to determine whether the driver is the authorized operator comprise instructions to:
build a contemporaneous driver profile based on contemporaneous sensor data;
access a driver profile database to obtain a historical driver profile; and
compare the contemporaneous driver profile with the historical driver profile to determine whether the driver profile and historical driver profile are different.
